(19) United States
(12) Patent Application Publication
(10) Pub. No.: US 2021/0305723 A1
(43) Pub. Date: Sep. 30, 2021

(54) JOINT STRUCTURE FOR CONNECTION OF FLAT ELECTRIC WIRE ASSEMBLY

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); SUMITOMO ELECTRIC PRINTED CIRCUITS, INC., Shiga (JP)

(72) Inventors: Shinichi TAKASE, Mie (JP); Takayuki TSUMAGARI, Shiga (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); SUMITOMO ELECTRIC PRINTED CIRCUITS, INC., Shiga (JP)

(21) Appl. No.: 17/262,373

(22) PCT Filed: Jul. 5, 2019
(86) PCT No.: PCT/JP2019/026792

§ 371 Date: Jan. 22, 2021

(30) Foreign Application Priority Data
Jul. 26, 2018 (JP) 2018-140354

(51) Int. Cl. H01R 4/02; H01R 12/77

(52) U.S. Cl. CPC H01R 4/023; H01R 12/771

(57) ABSTRACT

A joint structure includes an end portion of the flat electric wire assembly, a terminal fitting, and solder. The flat electric wire assembly includes a conductive line, a first insulating layer covering the conductive line, and a second insulating layer covering a portion of the conductive line. The terminal fitting includes a joint portion that includes a receiving section on which the end portion is placed and blocking sections extending from the receiving section such that the end portion is between the blocking sections. The first insulating layer includes a first surface opposed to the receiving section and a second surface on which the conductive line is disposed. The conductive line includes an end portion different from the portion covered with the second insulating layer. The solder is disposed over the second surface. The blocking sections include surfaces over which the solder is not disposed.

### TECHNICAL FIELD

The technology disclosed herein relates to a joint structure for connection of a flat electric wire assembly.

### BACKGROUND ART

A joint structure between a conductive line and a core wire of an electric cable has been known. In the joint structure, the core wire is placed on the conductive line and joined to the conductive line by soldering (refer to Patent Document 1).

### RELATED ART DOCUMENT

### [Patent Document]

[Patent Document 1] Japanese Unexamined Patent Application Publication No. 2003-217709

### SUMMARY OF THE INVENTION

### Problem to be Solved by the Invention

In such a joint structure, when a large force is applied to the electric cable, a crack may occur in a joint resulting in a reduction in reliability of the connection.

### Means for Solving the Problem

A joint structure for connection of a flat electric wire assembly described herein includes a flat electric wire assembly, a terminal fitting, and solder. The flat electric wire assembly includes a conductive line and an insulating layer. The conductive line has a band shape. The insulating layer covers the conductive line. The terminal fitting includes a joint portion joined to the electric wire assembly. The solder electrically connects the conductive line to the connector. The joint portion includes a receiving section on which the flat electric wire assembly is placed and two blocking sections. The blocking sections extend from the receiving section. The two blocking sections are disposed such that the flat electric wire assembly is between the blocking sections. The flat electric wire assembly includes a first surface opposed to the receiving section and a second surface that is an opposite side from the first surface. The conductive line is exposed from the insulating layer on a second surface side. The solder is disposed on the second surface.

According to the above configuration, during connection of the conductive line to the joint portion by soldering, the solder is blocked by the two blocking sections. Therefore, the solder is less likely to flow to the outside of the receiving section. Therefore, a solder fillet is properly formed and the reliability in connection between the flat electric wire assembly and the terminal fitting improves.

In the above configuration, the blocking sections may be opposed to the second surface of the flat electric wire assembly. Because the blocking sections are opposed to the second surface of the flat electric wire assembly, the strength of the joint between the flat electric wire assembly and the terminal fitting improves.

### Advantageous Effects of Invention

The joint structure for connection of the flat electric wire assembly disclosed herein can improve the connection reliability between the flat electric wire assembly and the terminal fitting.

### BRIEF DESCRIPTION OF THE DRAWINGS

FIG. 1 is a perspective view of a joint structure for connection of a flat electric wire assembly according to an embodiment.

FIG. 2 is an elevation view of the joint structure for connection of joining the flat electric wire assembly according to the embodiment.

FIG. 3 is a perspective view of a terminal fitting joined to an electric wire according to the embodiment.

FIG. 4 is a perspective view of the flat electric wire assembly according to the embodiment.

FIG. 5 is a perspective view illustrating the flat electric wire assembly placed on a receiving plate section according to the embodiment.

FIG. 6 is a perspective view illustrating a protective case in which a joint among the flat electric wire assembly, an electric wire, and the terminal fitting is disposed according to the embodiment.

FIG. 7 is a perspective view illustrating that a lower case in which the joint among the flat electric wire assembly, the electric wire, and the terminal fitting is disposed according to the embodiment.

FIG. 8 is a perspective view of a joint structure for connection of a flat electric wire assembly according to a modification.

FIG. 9 is an elevation view of the joint structure for connection of the flat electric wire assembly according to the modification.

### MODES FOR CARRYING OUT THE INVENTION

### Embodiment

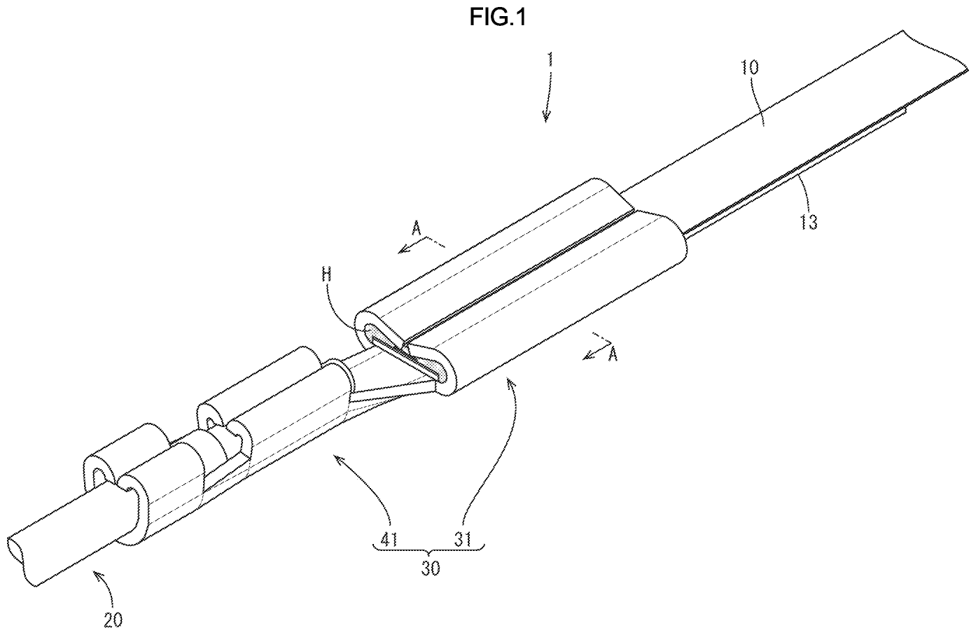

An embodiment will be described with reference to FIGS. 1 to 7. As illustrated in FIG. 1, a joint structure 1 for connection of a flat electric wire assembly 10 according to this embodiment includes a flat electric wire assembly 10, an electric wire 20, and a terminal fitting 30. The terminal fitting 30 connects the flat electric wire assembly 10 to the electric wire 20.

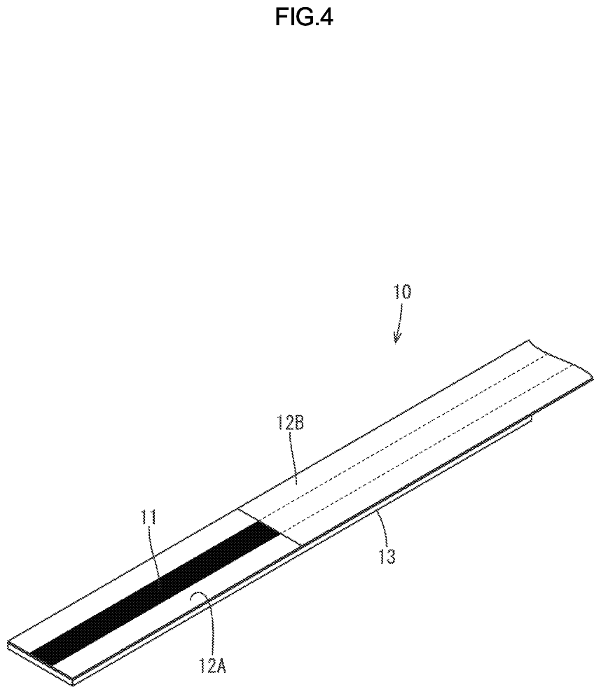

The flat electric wire assembly 10 includes a flexible printed circuit (FPC). As illustrated in FIG. 4, the flat electric wire assembly 10 has a flat plate shape that includes a front surface 10F (corresponding to a second surface) and a back surface 10R (corresponding to a first surface). The flat electric wire assembly 10 includes a conductive line 11 and insulating resin films 12 (an insulating layer). The conductive line 11 is formed from a copper foil. The conductive line 11 has a band shape. The insulating resin films 12 cover surfaces of the conductive line 11, respectively. A section of the insulating film 12 on the front surface 10F is removed from an end portion of the flat electric wire assembly 10 and the conductive line 11 is exposed. A reinforcement plate 13 is disposed on the back surface 10R of the flat electric wire assembly 10 to cover an entire area of an end portion of the back surface 10R to reinforce the end. The reinforcement plate 13 may be made of glass epoxy resin or polyimide resin. In FIGS. 1, 2 and 7, the flat electric wire assembly 10 is schematically illustrated without the conductive line 11 and the insulating resin film 12.

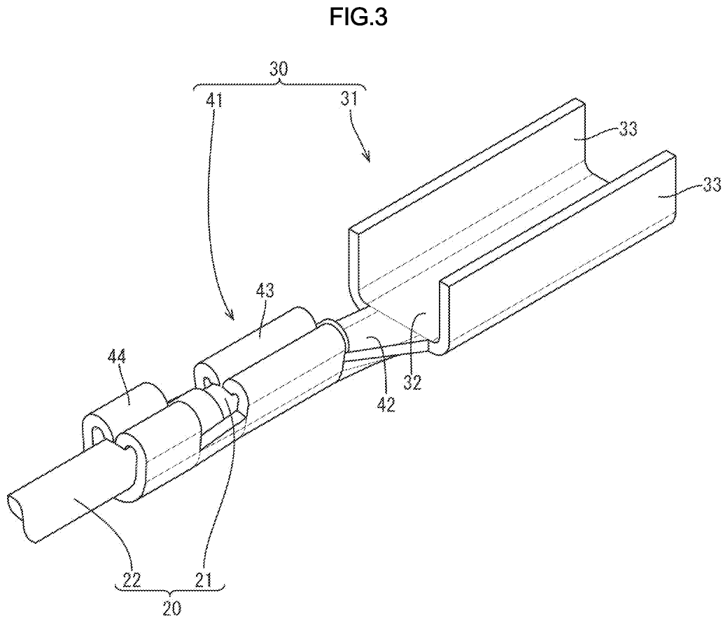

The electric wire assembly 20 including cupper electric wires has a known configuration. As illustrated in FIG. 3, the electric wire assembly 20 includes a core wire 21 and an insulating sheath 22. The core wire 21 includes bare electric wires made of copper or copper alloy and twisted. The insulating sheath 22 made of synthetic resin covers the core wire 21. A section of the insulating sheath 22 at an end portion of the electric wire assembly 20 is stripped and the core wire 21 is exposed.

As illustrated in FIG. 3, the terminal fitting 30 includes a first joint portion 31 (corresponding to a joint portion) to which the flat electric wire assembly 10 is joined and a second joint portion 41 to which the electric wire assembly 20 is joined.

As illustrated in FIG. 3, the first joint portion 31 has a U shape before the first joint portion 31 is joined to the flat electric wire assembly 10. A section of the first joint portion 31 at a bottom of the U shape is defined as the receiving plate section 32 (corresponding to the receiving section) on which the end portion of the flat electric wire assembly 10 is to be placed. The receiving plate section 32 has a flat plate shape. Sections of the first joint portion 31 at sides of the U shape extending from the receiving plate section 32 in the vertical direction are defined as blocking wall sections 33 (corresponding to blocking sections).

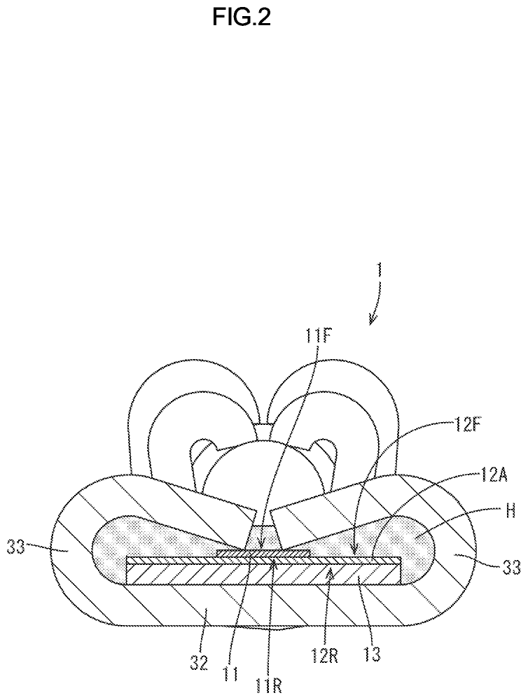

When the first joint portion 31 is joined to the flat electric wire assembly 10, the end portion of the flat electric wire assembly 10 is sandwiched between the receiving plate section 32 and the blocking walls 33 as illustrated in FIG. 2. The end portion of the flat electric wire assembly 10 is placed over the receiving plate section 32 such that the back surface 10R is opposed to the receiving plate section 32 and the front surface 10F is on an opposite side from the receiving plate section 32 relative to the back surface 10R. The back surface 10R is on which the reinforcement plate 13 is disposed. The front surface 10F from which the conductive line is exposed is covered with solder H. The solder H electrically connects the conductive line 11 to the first joint portion 31. The blocking walls 33 are bent inwardly such that distal ends (edges away from the receiving plate section 32) of the two blocking walls 33 face each other. The blocking walls 33 cover the end portion of the flat electric wire assembly 10 and the solder H on the front surface 10F.

As illustrated in FIG. 3, the second joint portion 41 includes a bottom plate 42, wire barrel portions 43, and insulation barrel portions 44. The bottom plate 42 has a band shape and extends from the receiving plate section 32. The wire barrel portions 43 extend upward from the bottom plate 42. The insulation barrel portions 44 extend upward from the bottom plate 42. The electric wire assembly 20 is connected to the second joint portion 41 with the wire barrel portions 43 are crimped to the core wire 21 that is exposed from the insulating sheath 22 at the end portion of the electric wire assembly 20 and the insulation barrel portions 44 are crimpled to a portion of the electric wire assembly 20 covered with the insulating sheath 22.

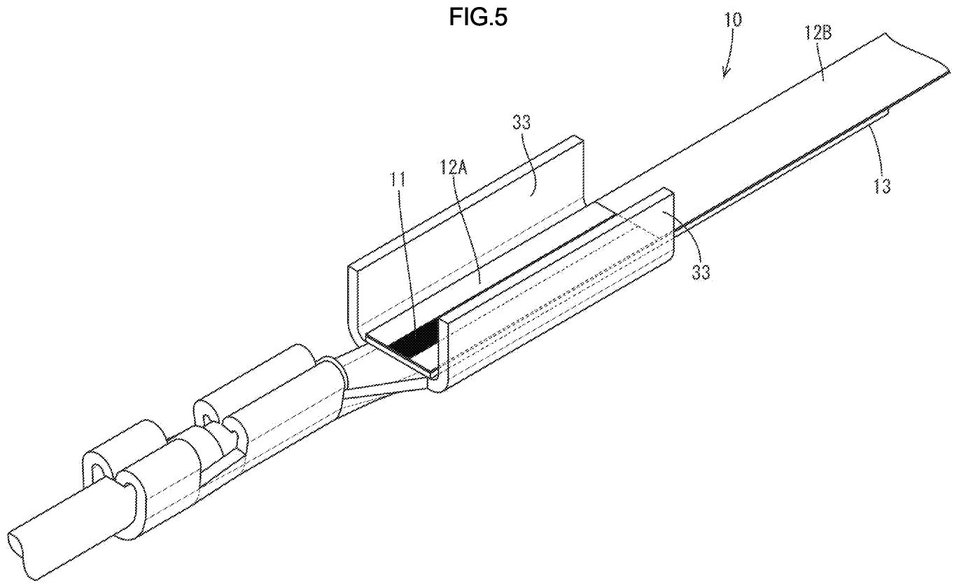

As illustrated in FIG. 5, the end portion of the flat electric wire assembly 10 is placed on the receiving plate section 32 for joining the flat electric wire assembly 10 to the first joint portion 31. The back surface 10R, on which the reinforcement plate is disposed, is opposed to the receiving plate section 32. The front surface 10F from which the conductive line 11 is exposed is on an opposite side from the receiving plate section 32 relative to the back surface 10R. The solder H is applied to the front surface 10F from which the conductive line 11 is exposed at the end for connecting the conductive line 11 to the first joint portion 31 by soldering. The solder H remains inside the U shape that is surrounded by the receiving plate section 32 and the two blocking walls 33. Therefore, the solder H is less likely to flow to the outside and thus a solder fillet is properly formed. The two blocking walls are bent inward such that distal ends of the blocking walls 33 are opposed to each other. Through these steps, the joining of the flat electric wire assembly 10 to the first joint portion 31 is complete.

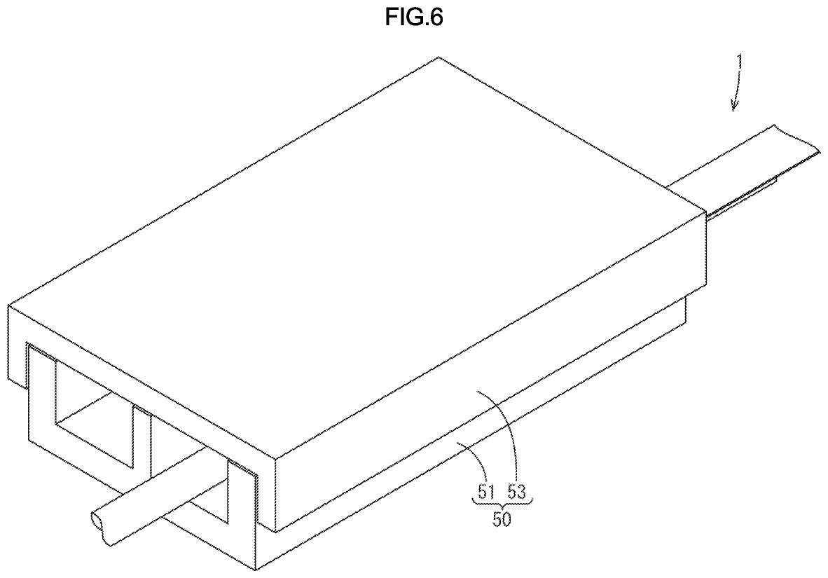

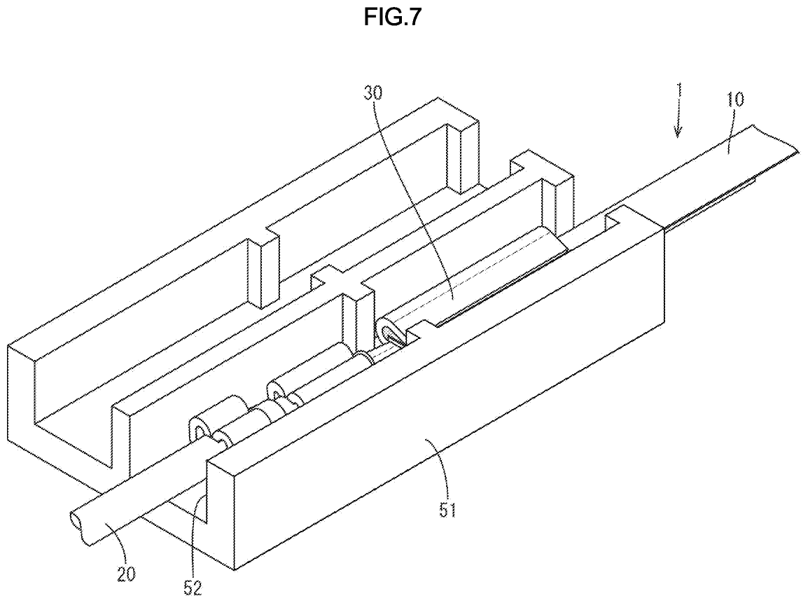

As illustrated in FIG. 6 and FIG. 7, the joint structure 1 of joining the flat electric wire assembly 10 to the electric wire assembly 20 and the terminal fitting 30 is held in the protective case 50 and protected. The protective case 50 includes a lower case 51 and an upper case 53. The lower case 51 includes a holding groove 52 in which the joint among the flat electric wire assembly 10, the electric wire assembly 20, and the terminal fitting 30 is held. The upper case 53 is fitted on the lower case 51. The upper case 53 covers the joint held in the holding groove 52.

As described above, the joint structure 1 of the flat electric wire assembly 10 according to this embodiment includes the flat electric wire assembly 10, the terminal fitting 30, and the solder H. The flat electric wire assembly 10 includes the conductive line 11 and the insulating resin films 12. The conductive line 11 has the band shape. The insulating resin films 12 cover the conductive line 11. The terminal fitting 30 includes the first joint portion 31 that is connected to the flat electric wire assembly 10. The solder H electrically connects the conductive line 11 to the first joint portion 31. The first joint portion 31 includes the receiving plate section 32 and the blocking walls 33. The flat electric wire assembly 10 is placed on the receiving plate section 32. The blocking walls 33 extend from the receiving plate section 32. The blocking walls 33 are disposed such that the flat electric wire assembly 10 is between the blocking walls 33. The flat electric wire assembly 10 includes the back surface 10R that is opposed to the receiving plate section 32 and the front surface 10F that is on the opposite side from the back surface 10R. The conductive line 11 is exposed from the insulating resin film 12 on a front surface 10F side. The solder H is disposed over the front surface 10F.

According to the above configuration, the solder H is blocked by the blocking walls 33 during connecting of the conductive line 11 to the first joint portion 31 with the solder H. Therefore, the solder H is less likely to flow to the outside of the receiving plate section 32. Therefore, the solder fillet is properly formed and reliability in connection between the flat electric wire assembly 10 and the terminal fitting 30 improves.

Furthermore, the blocking walls 33 are opposed to the front surface 10F of the flat electric wire assembly 10. This configuration improves the strength of the joint between the flat electric wire assembly 10 and the terminal fitting 30.

<Modification>

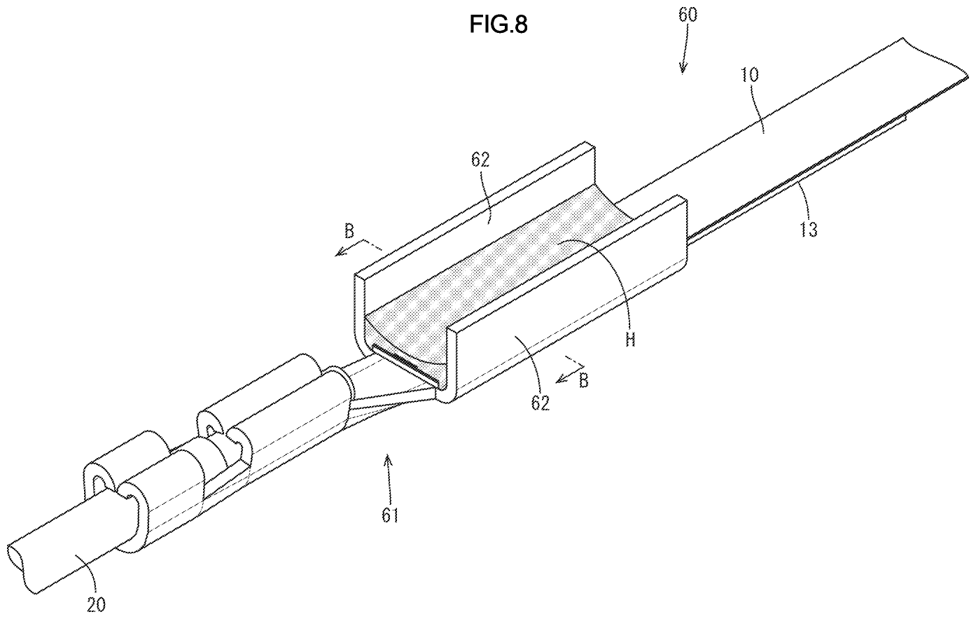

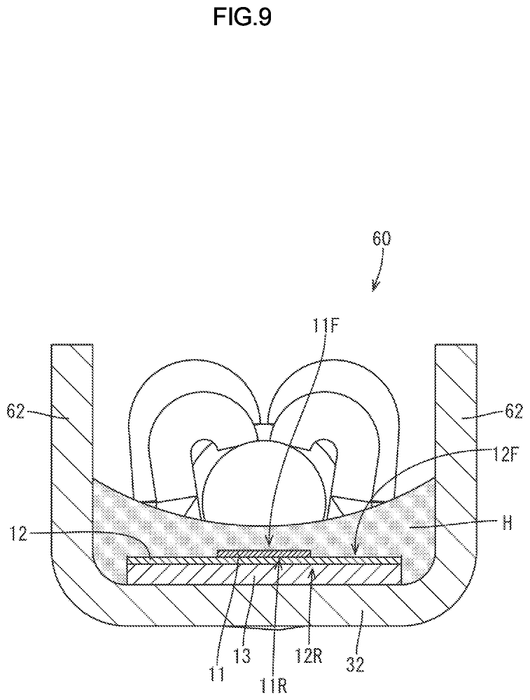

A joint structure 60 of the flat electric wire assembly 10 according to the modification is illustrated in FIGS. 8 and 9. A terminal fitting 61 in the modification includes two blocking walls 62 that are not bent after soldering. The blocking walls 62 extend upward from the receiving plate section 32. According to the configuration, the solder H is blocked by the blocking walls 62 during soldering. Therefore, the solder H is less likely to flow to the outside of the receiving plate section 32. As a result, a solder fillet is properly formed and reliability in connection between the flat electric wire assembly 10 and the terminal fitting 61 improves. Components or portions of the modification other than those described above may have configurations similar to the configurations of the above embodiment. The components or the portions may be indicated by the reference signs that indicate those of the above embodiment and will not be described.

### Other Embodiments

The technology disclosed herein is not limited to the embodiment and the modification that are illustrated in the above descriptions and drawings. Various embodiments such as the following embodiments may be included in the scope of the technology disclosed herein.

(1) The flat electric wire assembly 10 in the above embodiment or the modification includes the FPC. However, the configuration of the flat electric wire assembly 10 is not limited to this configuration. For example, the flat electric wire assembly 10 may include a flexible flat cable (FFC).

(2) In the above embodiment, the terminal fitting 30 includes the second joint portion 41 that is connected to the electric wire assembly 20. However, the terminal fitting may include a terminal connector that is connected to another terminal fitting.

### EXPLANATION OF SYMBOLS

1, 60: Joint structure for connection of flat electric wire assembly
10: Flat electric wire assembly
10F: Front surface (second surface)
10R: Back surface (first surface)
11: Conductive line
12: Insulating resin film (insulating layer)
30: Terminal fitting
31: First joint portion (joint portion)
32: Receiving plate section (receiving section)
33, 62: Blocking wall (the blocking section)
H: Solder

1. (canceled)

2. (canceled)

3. A joint structure for connection of the flat electric wire assembly comprising:
an end portion of the flat electric wire assembly, the flat electric wire assembly including:
a conductive line having a band shape;
a first insulating layer covering the conductive line; and
a second insulating layer covering a portion of the conductive line;
a terminal fitting including a joint portion joined to the end portion of the flat electric wire assembly, the joint portion including:
a receiving section on which the end portion of the flat electric wire assembly is placed; and
two blocking sections extending from the receiving section such that the end portion of the flat electric wire assembly is disposed between the blocking sections; and
solder electrically connecting the conductive line to the joint portion, wherein
the first insulating layer includes a first surface opposed to the receiving section and a second surface that is an opposite side from the first surface and on which the conductive line is disposed,
the conductive line includes an end portion included in the end portion of the flat electric wire assembly and different from the portion covered with the second insulating layer,
the solder is disposed over the second surface, and
the blocking sections include surfaces over which the solder is not disposed on an opposite side from the end portion of the flat electric wire assembly.

4. The joint structure for connection of the flat electric wire assembly according to claim 3, wherein
the blocking sections are opposed to the second surface of the first insulating layer.

5. The joint structure for connection of the flat electric wire assembly according to claim 3, further comprising a protective case protecting joint between the flat electric wire assembly and the terminal fitting, wherein
the protective case includes side walls extending in a direction perpendicular to the receiving section and disposed adjacent to side edges of the terminal fitting, respectively.

6. The joint structure for connection of the flat electric wire assembly according to claim 5, wherein
the protective case includes a first wall extending along the first surface and a second wall extending along the second surface, and
the terminal fitting is disposed in a space defined by the side walls, the first wall, and the second wall.

7. The joint structure for connection of the flat electric wire assembly according to claim 5, wherein
the protective case includes at least one protrusion protruding from at least one of the side walls toward the terminal fitting to position the joint portion when the protrusion contacts the joint portion.

8. The joint structure for connection of the flat electric wire assembly according to claim 5, wherein
the protective case includes:
a first protrusion protruding from one of the side walls toward the terminal fitting and being disposed adjacent to a first end edge of the blocking portion; and
a second protrusion protruding from the one of the side walls toward the terminal fitting and being disposed adjacent to a second end edge of the blocking portion.

9. A joint structure for connection of a flat electric wire assembly to an electric wire assembly comprising:
an end portion of the flat electric wire assembly, the flat electric wire assembly including:
a conductive line having a band shape;
a first insulating layer covering the conductive line; and
a second insulating layer covering a portion of the conductive line;
an end portion of the electric wire assembly, the electric wire assembly including a core wire an insulating sheath covering the core wire;
a terminal fitting including:
a first joint portion joined to the end portion of the flat electric wire assembly, the first joint portion including:
a receiving section on which the end portion of the flat electric wire assembly is placed; and
two blocking sections extending from the receiving section such that the end portion of the flat electric wire assembly is disposed between the blocking sections; and
a second joint portion joined to the end portion of the electric wire assembly; and
solder electrically connecting the conductive line to the joint portion, wherein
the first insulating layer includes a first surface opposed to the receiving section and a second surface that is an opposite side from the first surface and on which the conductive line is disposed,
the conductive line includes an end portion included in the end portion of the flat electric wire assembly and different from the portion covered with the second insulating layer,
the solder is disposed over the second surface, and
the blocking sections include surfaces over which the solder is not disposed on an opposite side from the end portion of the flat electric wire assembly.

10. The joint structure for connection of the flat electric wire assembly to the electric wire assembly according to claim 9, wherein
the blocking sections are opposed to the second surface of the first insulating layer.

11. The joint structure for connection of the flat electric wire assembly to the electric wire assembly according to claim 9, further comprising a protective case protecting joint between the flat electric wire assembly and the terminal fitting, wherein
the protective case includes side walls extending in a direction perpendicular to the receiving section and disposed adjacent to side edges of the terminal fitting, respectively.

12. The joint structure for connection of the flat electric wire assembly to the electric wire assembly according to claim 11, wherein
the protective case includes a first wall extending along the first surface and a second wall extending along the second surface, and
the terminal fitting is disposed in a space defined by the side walls, the first wall, and the second wall.

13. The joint structure for connection of the flat electric wire assembly to the electric wire assembly according to claim 11, wherein
the protective case includes at least one protrusion protruding from at least one of the side walls toward the terminal fitting to position the joint portion when the protrusion contacts the joint portion.

14. The joint structure for connection of the flat electric wire assembly to the electric wire assembly according to claim 11, wherein
the protective case includes:
a first protrusion protruding from one of the side walls toward the terminal fitting and being disposed adjacent to a first end edge of the blocking portion; and
a second protrusion protruding from the one of the side walls toward the terminal fitting and being disposed adjacent to a second end edge of the blocking portion.
